(19) United States
(12) Patent Application Publication
(10) Pub. No.: US 2005/0129032 A1
(43) Pub. Date: Jun. 16, 2005

(54) Binding management apparatus, binding management method, and computer readable recording medium storing program implementing binding management method

(75) Inventors: Yong-Ku Kim, Seoul (KR); Kyo-shin Choo, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/994,257

(22) Filed: Nov. 23, 2004

(30) Foreign Application Priority Data
Dec. 13, 2003 (KR) 2003-90966

(51) Int. Cl. H04L 12/56; H04L 12/28

(52) U.S. Cl. 370/400

(57) ABSTRACT

A binding management method and apparatus. The binding management apparatus includes a reference counter for managing entries in a binding update list in which binding update information is recorded. The binding management apparatus has a simple structure and a high operating speed because a low number of counters are used for binding management of a mobile node, a correspondent node, or a home agent.

### CROSS-REFERENCE TO RELATED APPLICATIONS

This application claims the priority of Korean Patent Application No. 2003-90966, filed on Dec. 13, 2003 in the Korean Intellectual Property Office, the disclosure of which is incorporated herein in its entirety by reference.

### BACKGROUND OF THE INVENTION

1. Field of the Invention

The present invention relates to binding management in a mobile IPv6 environment, and more particularly, to a binding management apparatus, a binding management method, and a computer readable recording medium storing the program implementing the binding management method.

2. Description of the Related Art

A mobile internet protocol (IP) has been developed to allow a mobile computer (or a node) to continually communicate with other nodes on the Internet in spite of changes of the Internet access point of the node due to movement of the node's location. All changes in the access environment due to such location movement and the continual dynamic link are accomplished in an automatic manner. The mobile IP provides such mobility support in an IP layer to allow a physical connection to change when the links over a transport layer are sustained.

Under typical mobile IP management, a home network and a home address (HoA), which is a non-changing IP address, are assigned to each mobile node, and then IP packets are relayed to the location of a mobile node via a home agent (HA), which is a router of the home network. A network to which a mobile node is connected is called a foreign network (FA). An IP address temporarily assigned in the FA is called a care-of address (CoA). Typically, the mobile node registers the CoA in the HA. Then, IP packets destined for the HoA of the mobile node are transmitted to the current location of the mobile node, the CoA.

The packets destined for a correspondent node (CN) from a mobile node (MN) are directly transmitted. The packets destined for the MN from the CN first pass through the HA. When the MN is located far from the HA, a path bypassing the HA brings about a transmission delay. Therefore, in the mobile IP management, the CN can obtain location information of the MN. For this purpose, the MN transmits the location information to the CN. This is called a binding update (BU). More specifically, when the MN transmits the information <HoA, CoA, BU lifetime> regarding itself to the CN, the CN stores the information in a binding cache. Then, if there is a packet to be transmitted to the MN, the CN searches the binding cache to deliver the packet by using the care-of address without passing through the HA.

Referring to FIG. 1, the MN 12 in the home link communicates with the CN 13. When the MN12 moves along path 2, the MN 12 detects such movement at position 3. Then, a CoA is temporarily assigned to the MN 12 in operation 4.

The MN 12 transmits a binding update on path 5 to register the temporarily assigned CoA with the HA 10. The HA 10 transmits a binding acknowledgement to the MN 12 in response on path 6.

Then, the MN 12 transmits the binding update to the CN 13 on path 7 to initiate communication with the CN 13. The CN 13 transmits a binding acknowledgement to the MN 12 in response on path 8.

The binding update is used by the MN 12 to notify the CN 13 or the HA 10 of the current binding status. The MN 12 retains a binding update list in which information regarding binding updates, which have lifetimes that have not expired, is recorded. The binding update list contains information regarding all binding updates transmitted by the MN 12.

Each entry contained in the binding update list includes an IP address and a home address of the node to which the binding update is transmitted, a care-of address transmitted for the binding update, and a remaining lifetime of the binding update. Such a lifetime is initialized using a lifetime field transmitted to the binding update message, and then decremented to zero. When zero is reached, the entry is deleted from the binding update list.

Referring to FIG. 2, the binding update list 20 includes entries 0 through N−1 having lifetime fields 0 through N−1, respectively. The lifetime fields are initialized by the lifetime field values transmitted with the binding update message. Timers are also initialized using the lifetime initialization values and are decremented to 0. When a value of the timer reaches zero, a corresponding entry is deleted.

Conventionally, a timer 0 25, a timer 1 26, a timer 2 27, . . . , and a timer N−1 28 for managing corresponding entries in the binding update list are prepared, separately.

The HA or CN includes a binding cache for managing the binding updates requested from the MN. A CN having an entry in a binding cache for a MN transmits a binding request to the MN when, for example, a time limit for the binding is almost reached, so that the corresponding binding can be refreshed.

Each entry in the binding cache also includes a remaining lifetime field, which is initialized using a lifetime value calculated according to a predetermined policy of the CN or the HA itself and then is decremented to zero. In addition, the corresponding entry is deleted from the binding cache when zero is reached.

Referring to FIG. 3, a binding cache 30 includes entries 0 through N−1. The entries 0 through N−1 include lifetime fields 0 through N−1, respectively. The lifetime fields are initialized using the lifetime values calculated according to a predetermined policy. Timers 0 through N−1 35 to 38 are also initialized using the lifetime initialization values and then are decremented to zero. A corresponding entry is deleted when the value of the timer reaches zero.

Conventionally, a timer 0 35, a timer 1 36, a timer 2 37, . . . , and a timer N−1 38 for managing corresponding entries in the binding cache are each prepared, separately.

As described above, according to conventional art, if there are N entries in a binding update list or a binding cache, each entry has an independent lifetime managed by a timer. Therefore, N timers are required in order to manage the entries having such independent lifetimes.

Unfortunately, the large number of timers required makes implementation of a mobile IP system complicated and reduces operating speed. Therefore, the entire system operates ineffectively.

### SUMMARY OF THE INVENTION

In accordance with an aspect of the present invention, a binding management apparatus, a binding management method, and a computer readable recording medium storing a program for implementing the binding management method, capable of simplifying a system and improving an operating speed are provided.

According to an aspect of the present invention, there is provided a binding management apparatus including a reference counter for managing entries in a binding update list in which binding update information is recorded.

According to another aspect of the present invention, there is provided a binding management apparatus including a reference counter performing a count operation in order to manage lifetimes of entries in a binding update list; and an entry management unit managing the entries in the binding update list based on a count value of the reference counter.

According to an aspect of the present invention, the entry management unit includes a lifetime setup unit setting the lifetime of one of the entries in the binding update list based on a first count value of the reference counter and a lifetime value in a binding acknowledgement message; and a lifetime check unit examining the lifetime of one of the entries in the binding update list based on a second count value of the reference counter in order to determine if the entry in the binding update list must be updated or deleted.

According to an aspect of the present invention, the lifetime check unit includes an expected matching entry check unit searching for an expected matching entry having a lifetime less than a predetermined value greater than the second count value of the reference counter in order to determine whether the entry in the binding update list is to be updated; and a matching entry check unit searching for a matching entry having a lifetime equal to the second count value of the reference counter in order to determine whether the entry in the binding update list is to be deleted.

According to an aspect of the present invention, the lifetime setup unit sets the lifetime of the entry in the binding update list as a sum of the first count value of the reference counter, a lifetime value in the binding acknowledgement message, and an adjustment value for making an adjustment to the lifetime to account for transmitting a message.

According to another aspect of the present invention, there is provided a binding management method including managing entries in a binding update list in which binding update information is recorded.

According to I another aspect of the present invention, there is provided a binding management method including performing a count operation in order to manage lifetimes of entries in a binding update list; and managing the entries in the binding update list based on a count value.

According to another aspect of the present invention, there is provided a binding management apparatus including a reference counter for managing entries in a binding cache in which binding information is recorded.

According to another aspect of the present invention, there is provide a binding management apparatus including a reference counter performing a count operation in order to manage lifetimes of entries in a binding cache; and an entry management unit managing the entries in the binding cache based on a count value of the reference counter.

In an aspect of the present invention, the entry management unit includes a lifetime setup unit setting the lifetime of one of the entries in the binding cache based on a first count value of the reference counter and a lifetime value to be transmitted with a binding acknowledgement message according to a predetermined policy; and a lifetime check unit examining the lifetime of one of the entries in the binding cache based on a second count value of the reference counter in order to determine if the entry in the binding cache must be updated or deleted.

In an aspect of the present invention, the lifetime check unit includes an expected matching entry check unit searching for an expected matching entry having a lifetime less than a predetermined value greater than the second count value of the reference counter in order to determine if a binding refresh request should be sent in order to update the entry in the binding cache; and a matching entry check unit which searching for a matching entry having a lifetime equal to the second count value of the reference counter in order to determine if the entry in the binding cache is to be deleted.

According to an aspect of the present invention, the lifetime setup unit sets the lifetime of the entry in the binding cache as a sum of the first count value of the reference counter and a lifetime value to be transmitted with a binding acknowledgement message according to a predetermined policy.

According to another aspect of the present invention, there is provided a binding management method including managing entries in a binding cache in which binding information is recorded.

According to another aspect of the present invention, there is provided a computer readable recording medium on which a program for implementing a binding management method is stored, the binding management method including performing a count operation in order to manage lifetimes of entries in a binding update list by using a reference counter; and managing the entries in the binding update list based on a count value.

According to another aspect of the present invention, there is provided a computer readable recording medium on which a program for implementing a binding management method is stored, the binding management method comprising performing count operation so as to manage lifetimes of entries in a binding cache by using a reference counter; and managing the entries in the binding cache based on a count value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conventional schematic diagram for describing a binding update operation;

FIG. 2 is a schematic diagram for describing conventional lifetime management for entries contained in a binding update list;

FIG. 3 is a schematic diagram for describing conventional lifetime management for entries contained in a binding cache;

FIG. 4 is a schematic diagram illustrating lifetime management for entries contained in a binding update list according to an embodiment of the present invention;

FIG. 5 is a schematic diagram illustrating lifetime management for entries contained in a binding cache according to an embodiment of the present invention;

FIG. 6 is a block diagram of a binding management apparatus for managing a binding update list according to an embodiment of the present invention;

FIG. 7 is a block diagram of a binding management apparatus for managing a binding cache according to an embodiment the present invention;

FIG. 8 is a flow chart illustrating a method of setting lifetime fields of entries contained in a binding update list according to an embodiment of the present invention;

FIG. 9 is a flow chart illustrating operation of examining lifetimes of entries contained in a binding update list according to an embodiment of the present invention;

FIG. 10 is a flow chart illustrating operation of setting a lifetime field of an entry contained in a binding cache according to an embodiment of the present invention; and

FIG. 11 is a flow chart illustrating operation of examining lifetimes of entries contained in a binding cache according to an embodiment the present invention.

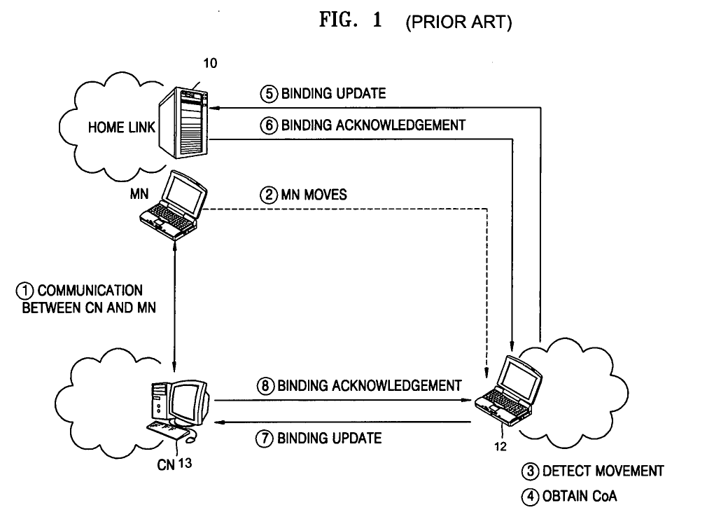

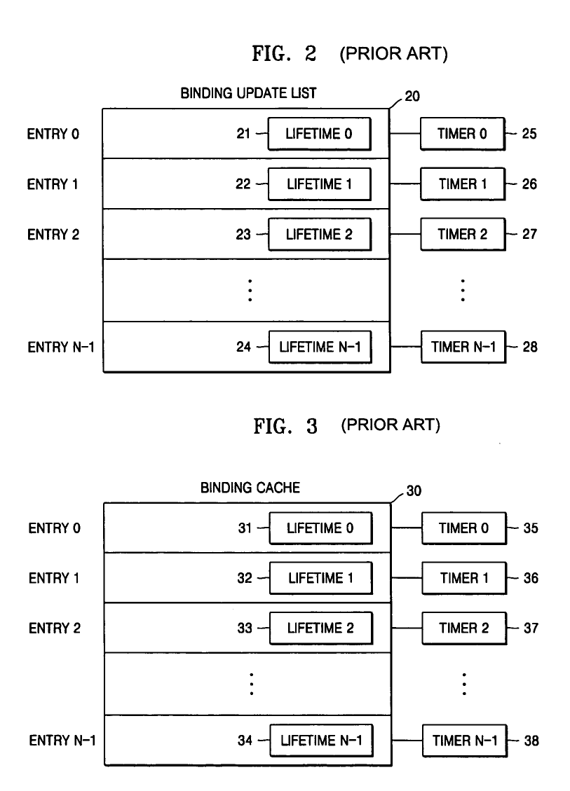

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

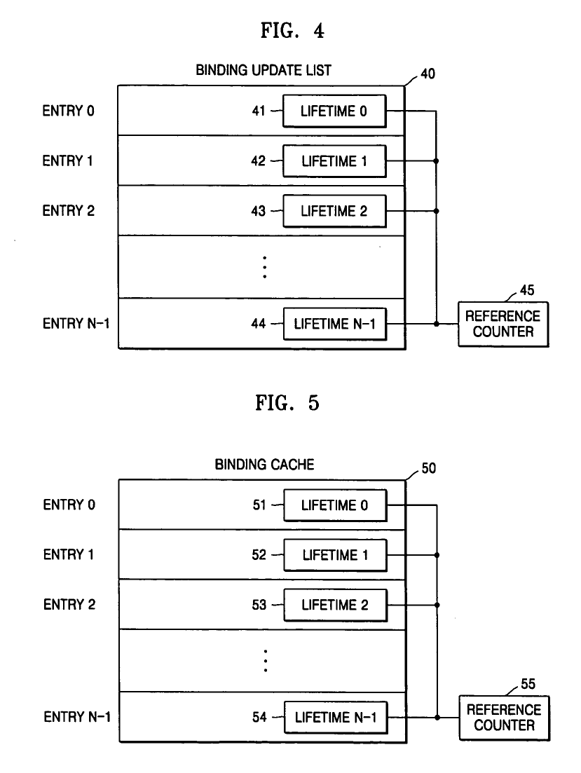

Referring to FIG. 4, a binding update list 40 comprises entries 0 through N−1 having lifetimes 0 through N−1, respectively. A reference counter 45 commonly manages all the entries in the binding update list 40. Such a common counter that manages the entries in the binding update list 40 according to an embodiment of the present invention can reduce hardware complexity. A detailed description is given below.

Referring to FIG. 5, a binding cache 50 comprises entries 0 through N−1 having lifetimes 0 through N−1, respectively. A reference counter 55 manages all the entries in the binding cache 50. Such a common counter that manages the entries in the binding cache 50 according to an embodiment of the present invention can reduce hardware complexity. A detailed description is given below.

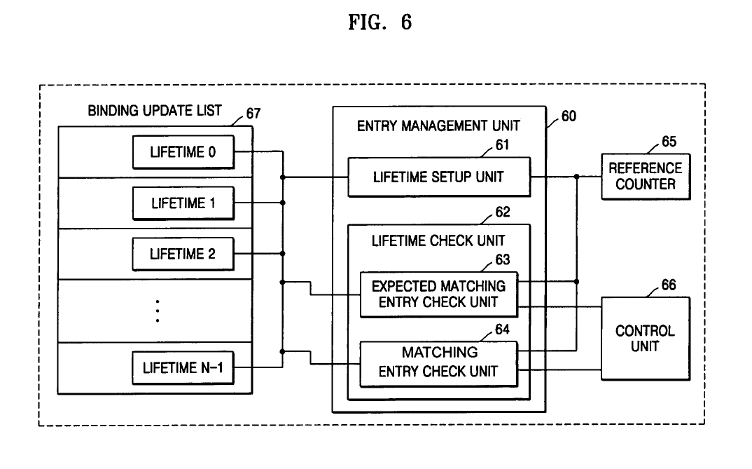

Referring to FIG. 6, a binding management apparatus comprises an entry management unit 60, a reference counter 65, a control unit 66, and a binding update list 67. The binding management apparatus may reside on a server in the mobile network or on a mobile node in the mobile network.

The reference counter 65 performs a count operation in order to manage each of the lifetimes 0 to N−1 of the entries in the binding update list 67. The count operation is performed in an incremental manner using a clock.

The entry management unit 60 performs management such as generating, updating, or deleting the entries in the binding update list 67 based on the count values of the reference counter 65. More specifically, the entry management unit 60 comprises a lifetime setup unit 61 and a lifetime check unit 62.

The lifetime setup unit 61 sets or updates a lifetime value of an entry in the binding update list 67. In other words, the lifetime setup unit 61 establishes the lifetime of an entry contained in the binding update list as the sum of a first count value (any number) of the reference counter 65, a predetermined lifetime value, and an adjustment value. When a mobile node (MN) first sends a binding update, or a binding acknowledgement is not received from a correspondent node (CN), a predetermined value designated by the MN can be used as the predetermined lifetime value. When the MN receives the binding acknowledgement, a lifetime value transmitted with the binding acknowledgement message can be used. The adjustment value is determined by considering a time required to transmit a message, and may be zero.

The lifetime check unit 62 checks the lifetime of the entry contained in the binding update list based on a second count value of the reference counter 65 in order to determine if the entry in the binding update list 67 must be updated or deleted. The second count value is a count value of the reference counter 65 when the lifetime check unit 62 performs a check, which occurs while the reference counter 65 continues to perform the count operation. The lifetime check unit 62 comprises an expected matching entry check unit 63 for determining when an entry in the binding update list 67 is to be updated and a matching entry check unit 64 for determining when an entry is to be deleted.

The expected matching entry check unit 63 searches for an expected matching entry having a lifetime less than a predetermined value greater than the second count value of the reference counter 65 in order to determine if an entry in the binding update list 67 is to be updated. If an expected matching entry is found as a result of the search by the expected matching entry check unit 63, the expected matching entry check unit 63 can send a predetermined signal to the control unit 66 in order to control transmission of the binding update to the CN corresponding to the expected matching entry.

The matching entry check unit 64 searches for a matching entry having a lifetime that is the same as the second count value of the reference counter 65 in order to determine whether an entry in the binding update list 67 is to be deleted. If a matching entry is found as a result of the search by the matching entry check unit 64, the matching entry check unit 64 can send a predetermined signal to the control unit 66 in order to control the deletion of the matching entry.

The control unit 66 controls transmission of the binding update to the CN or deletion of the matching entry according to a predetermined signal received from the expected matching entry check unit 63 or the matching entry check unit 64.

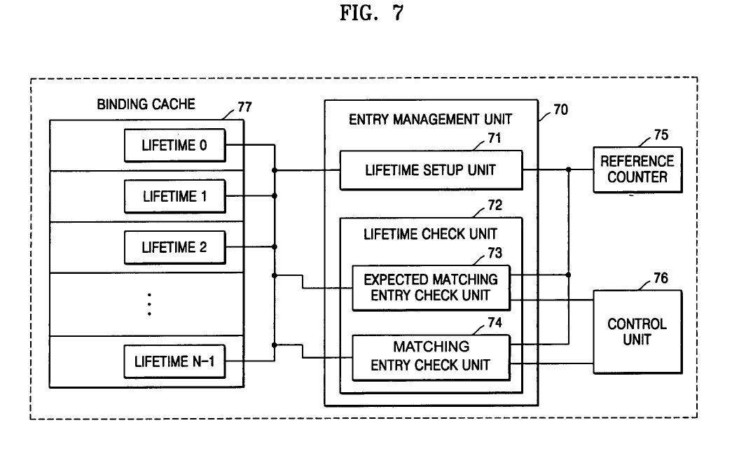

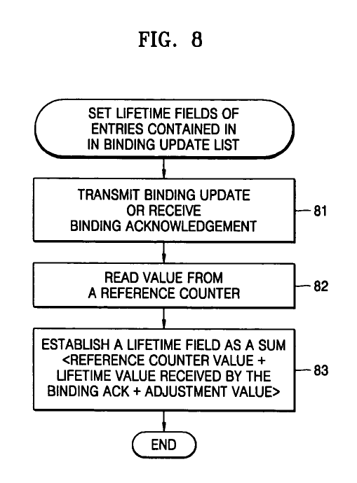

FIG. 7 is a block diagram of a binding management apparatus for managing a binding cache according to an embodiment of the present invention. The binding management apparatus shown in FIG. 7 is similar to the binding management apparatus shown in FIG. 6.

The binding management apparatus comprises an entry management unit 70, a reference counter 75, a control unit 76, and a binding cache 77.

The reference counter 75 performs a count operation in order to manage the lifetimes in the entries in the binding cache. The count operation is performed in an incremental manner using a clock.

The entry management unit 70 performs management such as generating, updating, or deleting entries in the binding cache 77 on the basis of the count values of the reference counter 75.

More specifically, the entry management unit 70 comprises a lifetime setup unit 71 and a lifetime check unit 72.

The lifetime setup unit 71 sets or updates a lifetime value of an entry in the binding cache 77. In other words, the lifetime setup unit 71 establishes the lifetime of an entry in the binding cache 77 as the sum of a first count value (any number) of the reference counter 75 and a lifetime value calculated according to a predetermined policy, to be transmitted with a binding acknowledgement message.

The lifetime check unit 72 examines the lifetime of an entry contained in the binding cache 77 based on a second count value of the reference counter 75 in order to determine if the entry in the binding cache 77 must be updated or deleted. The second count value is a count value of the reference counter 75 when the lifetime check unit 72 performs the check, which occurs while the reference counter 75 continues to perform the count operation. The lifetime check unit 72 comprises an expected matching entry check unit 73 for determining when an entry in the binding cache 77 is to be updated and a matching entry check unit 74 for determining when an entry is to be deleted.

The expected matching entry check unit 73 searches for an expected matching entry having a lifetime less than a predetermined value greater than the second count value of the reference counter 75 in order to determine if an entry in the binding cache 77 is to be updated. If an expected matching entry is found as a result of the search by the expected matching entry check unit 73, the expected matching entry check unit 73 can send a predetermined signal to the control unit 76 in order to control transmission of a binding refresh request (BRR) to the CN corresponding to the expected matching entry.

The matching entry check unit 74 searches for a matching entry having a lifetime that is the same as the second count value of the reference counter 75 in order to determine whether an entry in the binding cache 77 is to be deleted. If a matching entry is found as a result of the search by the matching entry check unit 74, the matching entry check unit 74 can send a predetermined signal to the control unit 76 in order to control the deletion of the matching entry.

The control unit 76 controls transmission of the binding update to the CN or deletion of the matching entry according to a predetermined signal received from the expected matching entry check unit 73 or the matching entry check unit 74.

A binding management method will now be described in detail. FIG. 8 is a flow chart illustrating a method of setting lifetime fields of entries contained in a binding update list according to an embodiment of the present invention.

The MN sets lifetime fields of the entries in the binding update list when a binding update is transmitted or a binding acknowledgement is received in operation 81.

The lifetime setup unit 61 of the binding management apparatus reads a count value from the reference counter 65 in operation 82.

Then, the lifetime setup unit 61 sets a lifetime field of an entry contained in the binding update list as the sum of the count value read from the reference counter 65, the lifetime value received with the binding acknowledgement, and a predetermined adjustment value in operation 83. For example, when a lifetime field of the entry 0 is set, if the count value read from the reference counter 65 is 100, the lifetime value received by the binding acknowledgement is 20, and the adjustment value is 0, then the lifetime field of the entry 0 is set to 120.

The lifetime value is established as described above when a binding acknowledgement message is received. On the other hand, when a binding update is transmitted for the first time, a lifetime value determined arbitrarily by the MN is used for the above calculation.

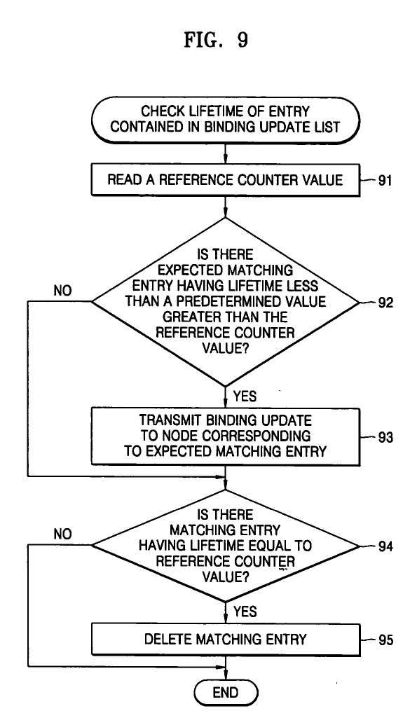

FIG. 9 is a flow chart illustrating an operation of examining lifetimes of entries contained in a binding update list according to an embodiment of the present invention.

First, the lifetime check unit 62 reads a count value from the reference counter 65 in operation 91.

Then, the expected matching entry check unit 63 searches for an expected matching entry having a lifetime less than a predetermined value based on the read reference counter value as described above in operation 92. For example, assume that the value of the reference counter 65 is 100, the lifetime is set, and the reference counter 65 stores the value 117. The expected matching entry check unit 63 searches for an expected matching entry having a lifetime less than a predetermined number greater than the reference counter value of 117 in the binding update list. Then, if, for example, the predetermined number is 5, the entry 0 having a lifetime of 120 will be selected.

When an expected matching entry is found as a result of the search, the expected matching entry check unit 63 transmits a predetermined signal to the control unit 66. Then, the control unit 66 controls transmission of the binding update to the node corresponding to the expected matching entry according to the predetermined signal in operation 93.

When no expected matching entry is found as a result of the search, the matching entry check unit 64 searches for a matching entry having a lifetime equal to the reference counter value in operation 94.

When a matching entry is found, the matching entry check unit 64 transmits a predetermined signal to the control unit 66. Then, the control unit 66 controls deletion of the corresponding matching entry according to a predetermined signal in operation 95.

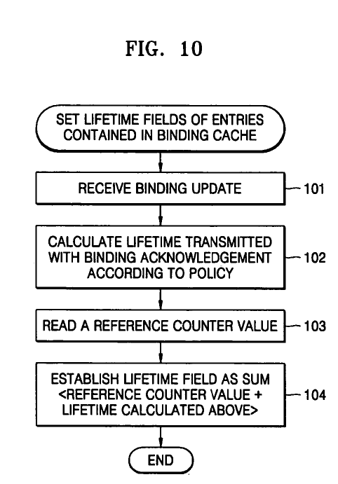

FIG. 10 is a flow chart illustrating an operation of setting a lifetime field of an entry contained in a binding cache according to an embodiment of the present invention.

When the CN or a home agent (HA) receives a binding update, the lifetime field of the entry contained in the binding cache starts to be set up in operation 101.

First, the lifetime setup unit 71 of the binding management apparatus calculates a lifetime to be transmitted with the binding acknowledgement message according to a predetermined policy in operation 102.

Then, the lifetime setup unit 71 reads a count value from the reference counter 75 in operation 103.

Subsequently, in operation 104 the lifetime setup unit 71 sets the lifetime field of an entry contained in the binding cache as the sum of the count value read out from the reference counter 75 and the lifetime value calculated in operation 102 104. For example, when the lifetime field of the entry 0 is to be set, if the count value read from the reference counter 65 is 100, and the calculated lifetime value is 20, the lifetime field of the entry 0 is set to 120.

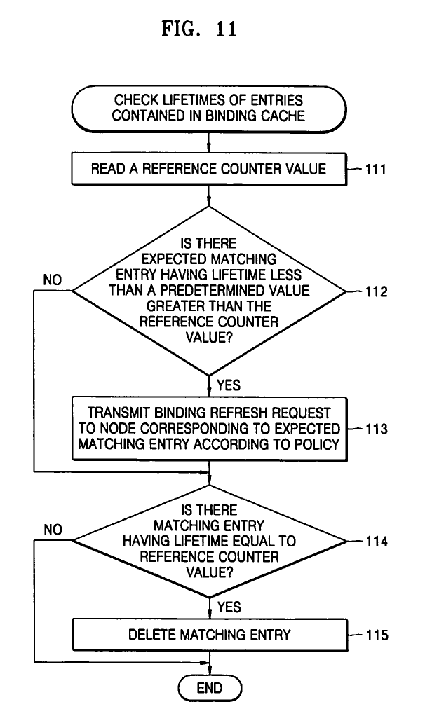

FIG. 11 is a flow chart illustrating operation of examining lifetimes of entries contained in a binding cache according to an embodiment the present invention.

First, a lifetime check unit 72 reads a count value from the reference counter 75 in operation 111.

Then, the expected matching entry check unit 73 searches for an expected matching entry having a lifetime less than a predetermined value based on the read reference counter value as described above in operation 112. For example, assume that the value of the reference counter 75 is 100, the lifetime is set, and the reference counter 75 stores the value of 117, the expected matching entry check unit 73 searches for an expected matching entry having a lifetime less than a predetermined number greater than the reference counter value of 117 in the binding cache. Then, if, for example, the predetermined number is 5, an entry 0 having a lifetime of 120 will be selected.

When an expected matching entry is found as a result of the search, the expected matching entry check unit 73 transmits a predetermined signal to the control unit 76. Then, the control unit 76 receives the predetermined signal and controls transmission of a binding refresh request to a node corresponding to the expected matching entry according to a predetermined policy in operation 113.

When no expected matching entry is found as a result of the search, the matching entry check unit 74 searches for a matching entry having a lifetime equal to the reference counter value in operation 114.

When a matching entry is found as a result of the search, the matching entry check unit 74 transmits a predetermined signal to the control unit 76. The control unit 76 controls deletion of the corresponding matching entry in response to the predetermined signal in operation 115.

The binding management method described above can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems such that the computer readable code is stored and executed in a distributed fashion.

According to an embodiment of the present invention, it is possible to reduce the number of the counters used for binding management in a mobile node, a correspondent node or a home agent. Therefore, a system can be simplified and its operating speed can be improved.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims and their equivalents, and all differences within the scope will be construed as being included in the present invention.

1. A binding management apparatus, comprising:
a reference counter managing entries in a binding update list in which binding update information is recorded.

2. A binding management apparatus, comprising:
a reference counter performing a count operation in order to manage lifetimes of entries in a binding update list; and
an entry management unit managing the entries in the binding update list based on a count value of the reference counter.

3. The binding management apparatus according to claim 2, wherein the entry management unit comprises:
a lifetime setup unit setting the lifetime of one of the entries in the binding update list based on a first count value of the reference counter and a lifetime value in a binding acknowledgement message; and
a lifetime check unit checking the lifetime of another one of the entries in the binding update list based on a second count value of the reference counter in order to determine if the other one of the entries in the binding update list must be updated or deleted.

4. The binding management apparatus according to claim 3, wherein the lifetime check unit comprises:
an expected matching entry check unit searching an expected matching entry having a lifetime less than a predetermined value greater than the second count value of the reference counter in order to determine whether the other one of the entries in the binding update list is to be updated; and
a matching entry check unit searching a matching entry having a lifetime equal to the second count value of the reference counter in order to determine whether the other one of the entries in the binding update list is to be deleted.

5. The binding management apparatus according to claim 3, wherein the lifetime setup unit sets the lifetime of the one of the entries in the binding update list as a sum of the first count value of the reference counter, the lifetime value in the binding acknowledgement message, and an adjustment value making an adjustment to the lifetime of the one of the entries to account for transmitting a message.

6. A binding management method, comprising managing entries in a binding update list in which binding update information is recorded by using a reference counter.

7. A binding management method, comprising:
performing a count operation in order to manage lifetimes of entries in a binding update list by using a reference counter; and
managing the entries in the binding update list based on a count value counted by the reference counter.

8. The binding management method according to claim 7, wherein the managing the entries in the binding update list further comprises:
setting the lifetime of one of the entries in the binding update list based on a lifetime value in a binding acknowledge message and a first count value of the reference counter; and
checking the lifetime of another one of the entries in the binding update list based on a second count value in order to determine if the other of the entries in the binding update list must be updated or deleted.

9. The binding management method according to claim 8, wherein the checking the lifetime of the other one of the entries comprises:
searching for an expected matching entry having a first lifetime less than a predetermined value greater than the second count value in order to determine whether the other one of the entries in the binding update list is to be updated; and
searching for a matching entry having a second lifetime equal to the second count value in order to determine whether the other one of the entries in the binding update list is to be deleted.

10. The binding management method according to claim 8, wherein the setting the lifetime of the one of the entries, comprises setting a sum of the first count value, the lifetime value in the binding acknowledgement message, and an adjustment value for making an adjustment to the lifetime to account for transmitting a message as the lifetime of the one of the entries.

11. A binding management apparatus comprising a reference counter managing entries in a binding cache in which binding information is recorded.

12. A binding management apparatus, comprising:
a reference counter performing a count operation in order to manage lifetimes of entries in a binding cache; and
an entry management unit managing the entries in the binding cache based on a count value of the reference counter.

13. The binding management apparatus according to claim 12, wherein the entry management unit comprises:
a lifetime setup unit setting the lifetime of one of the entries in the binding cache based on a first count value of the reference counter and a lifetime value to be transmitted with a binding acknowledgement message according to a predetermined policy; and
a lifetime check unit checking the lifetime of another one of the entries in the binding cache based on a second count value of the reference counter in order to determine if the other one of the entries in the binding cache must be updated or deleted.

14. The binding management apparatus according to claim 13, wherein the lifetime check unit comprises:
an expected matching entry check unit searching for an expected matching entry having a lifetime less than a predetermined value greater than the second count value of the reference counter in order to determine if a binding refresh request should be sent in order to update the other one of the entries in the binding cache; and
a matching entry check unit which searching for a matching entry having a lifetime equal to the second count value of the reference counter in order to determine if the other one of the entries in the binding cache is to be deleted.

15. The binding management apparatus according to claim 13, wherein the lifetime setup unit sets the lifetime of the one of the entries in the binding cache as a sum of the first count value of the reference counter and the lifetime value to be transmitted with the binding acknowledgement message according to the predetermined policy.

16. A binding management method, comprising
managing entries in a binding cache in which binding information is recorded by using a reference counter.

17. A binding management method, comprising:
performing a count operation in order to manage lifetimes of entries in a binding cache by using the reference counter; and
managing the entries in the binding cache based on a count value counted by the reference counter.

18. The binding management method according to claim 17, wherein the managing the entries in the binding cache comprises:
setting the lifetime of one of the entries in the binding cache based on a first count value and a lifetime value to be transmitted with a binding acknowledgement message according to a predetermined policy; and
checking the lifetime of another one of the entries in the binding cache based on a second count value in order to determine if the other one of the entries in the binding cache must be updated or deleted.

19. The binding management method according to claim 18, wherein the examining the lifetime of the one of the entries comprises:
searching for an expected matching entry having a lifetime less than a predetermined value greater than the second count value in order to determine if a binding refresh request should be transmitted to update the other one of the entries in the binding cache; and
searching for a matching entry having a lifetime equal to the second count value in order to determine if the other one of the entries in the binding cache is to be deleted.

20. The binding management method according to claim 18, wherein the setting the lifetime of the one of the entries comprises setting the lifetime of the one of the entries as a sum of the first count value and the lifetime value to be transmitted with the binding acknowledgement message according to the predetermined policy.

21. A computer readable recording medium on which a program for implementing a binding management method is stored, the binding management method comprising:
performing a count operation in order to manage lifetimes of entries in a binding update list by using a reference counter; and
managing the entries in the binding update list based on a count value.

22. A computer readable recording medium on which a program for implementing a binding management method is stored, the binding management method comprising:
performing count operation so as to manage lifetimes of entries in a binding cache by using a reference counter; and
managing the entries in the binding cache based on a count value.

23. A mobile network binding management apparatus, comprising:
an entry manager maintaining a list of binding entries each having a lifetime;
a single reference counter performing an incremental counting operation, wherein the entry manager maintains the lifetime of each binding entry according to a count value of the reference counter.

24. A mobile network, comprising:
at least one server;
at least one mobile node communicating with the at least one server;
a binding management apparatus which manages network address information for the at least one mobile node and the at least one server such that the communicating is maintained regardless of movement of the at least one mobile node, comprising:
an entry manager maintaining a list of binding entries each having a lifetime;
a single reference counter performing an incremental counting operation, wherein the entry manager maintains the lifetime of each binding entry according to a count value of the reference counter.
